(19) United States
(12) Patent Application Publication
(10) Pub. No.: US 2017/0169102 A1
(43) Pub. Date: Jun. 15, 2017

(54) METHOD AND ELECTRONIC DEVICE FOR CONTROLLING DATA QUERY

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Hongbin LIU, Beijing (CN); Tielong GUO, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/241,972

(22) Filed: Aug. 19, 2016

Related U.S. Application Data
(63) Continuation of application No. PCT/CN2016/089283, filed on Jul. 7, 2016.

(30) Foreign Application Priority Data
Dec. 15, 2015 (CN) 201510939191.2

(51) Int. Cl. G06F 17/30; G06F 17/27

(52) U.S. Cl. CPC G06F 17/30669; G06F 17/30684; G06F 17/271; G06F 17/277

(57) ABSTRACT

The present disclosure relates to a method and an electronic device for controlling data query, wherein, the method includes: acquiring an original query language input by a user; obtaining language information corresponding to the original query language by performing language analysis on the original query language; judging whether the language information meets a preset restrictive condition; when the language information meets the preset restrictive condition, obtaining a target query language by performing a language processing on the original query language according to the preset restrictive condition; sending the target query language to a preset server to make the preset server return a query content corresponding to the target query language.

### CROSS-REFERENCE TO RELATED APPLICATIONS

The present application is the continuous application of the PCT application PCT/CN2016/089283, filed on Jul. 7, 2016. The present disclosure claims priority to the Chinese patent application No. 201510939191.2, entitled “METHOD AND DEVICE FOR CONTROLLING DATA QUERY”, and filed with the Patent Office of the People's Republic of China on Dec. 15, 2015, which is incorporated herein by reference in its entirety.

### TECHNICAL FIELD

The present disclosure relates to the field of data processing technologies, and in particular, to a method and an electronic device for controlling data query.

### BACKGROUND

When data query is performed on a relational database, a database query language such as Structured Query Language (SQL) will be required for carrying on the corresponding data query.

At present, there mainly exist two methods for performing data query by utilizing a database query language: static query and dynamic query. In either method, a user needs to input a query language to a foreground interactive system, and then the interactive system sends the query language to a database system for query.

However, for a multi-user database system, different users have different query rights. If the interactive system simply forwards the query language input by a user to the database query system, it is most likely that information, which does not belong to the user, is leaked out.

### SUMMARY

In order to overcome the problem of the prior art, the present disclosure provides a method and an electronic device for controlling data query.

According to the first aspect of the embodiments of the present disclosure, there provides a method for controlling data query, which includes:

acquiring an original query language input by a user;

obtaining language information corresponding to the original query language by performing language analysis on the original query language;

judging whether the language information meets a preset restrictive condition;

obtaining a target query language by performing a language processing on the original query language according to the preset restrictive condition, when the language information meets the preset restrictive condition; and

sending the target query language to a preset server so as to make the preset server return a query content corresponding to the target query language.

According to the second aspect of the embodiments of the present disclosure, there further provides an electronic device, which includes: one or more processor; and a memory; wherein the memory stores instructions that are executable by the one or more processor, and the instructions are configured to execute any one of the method for controlling data query aforementioned of the present disclosure.

According to the third aspect of the embodiments of the present disclosure, there further provides a computer storage medium which stores computer-executable instructions for executing any one of the method for controlling data query of the present disclosure.

It should be understood that, the general description above and the detailed description below are exemplary and illustrative only, rather than limiting the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for controlling data query according to an exemplary embodiment;

FIG. 2 is a flow chart of another method for controlling data query according to an exemplary embodiment;

FIG. 3 is a schematic flow chart of Step S102 in FIG. 1;

FIG. 4 is a structural representation of a syntax tree according to an embodiment of the present disclosure;

FIG. 5 is a schematic flow chart of Step S104 in FIG. 1;

FIG. 6 is a structural representation of another syntax tree according to an embodiment of the present disclosure;

FIG. 7 is a structural representation of yet another syntax tree according to an embodiment of the present disclosure;

FIG. 8 is a structural representation of a device for controlling data query according to an embodiment of the present disclosure;

FIG. 9 is a structural representation of a language analysis module in FIG. 8;

FIG. 10 is a structural representation of a language processing module 14 in FIG. 8.

FIG. 11 is a structural representation of an electronic device according to an embodiment of the present disclosure.

### DETAILED DESCRIPTION

Exemplary embodiments, of which the examples are shown in the drawings, will be illustrated in detail here. When the description below is related to the drawings, the same number in the different drawings represents the same or similar element, unless otherwise expressed. The implementation modes described in the following exemplary embodiments do not represent all the implementation modes consistent with the present disclosure. Instead, they are only examples of the device and the method consistent with some aspects of the present disclosure as described in detail in the claims appended.

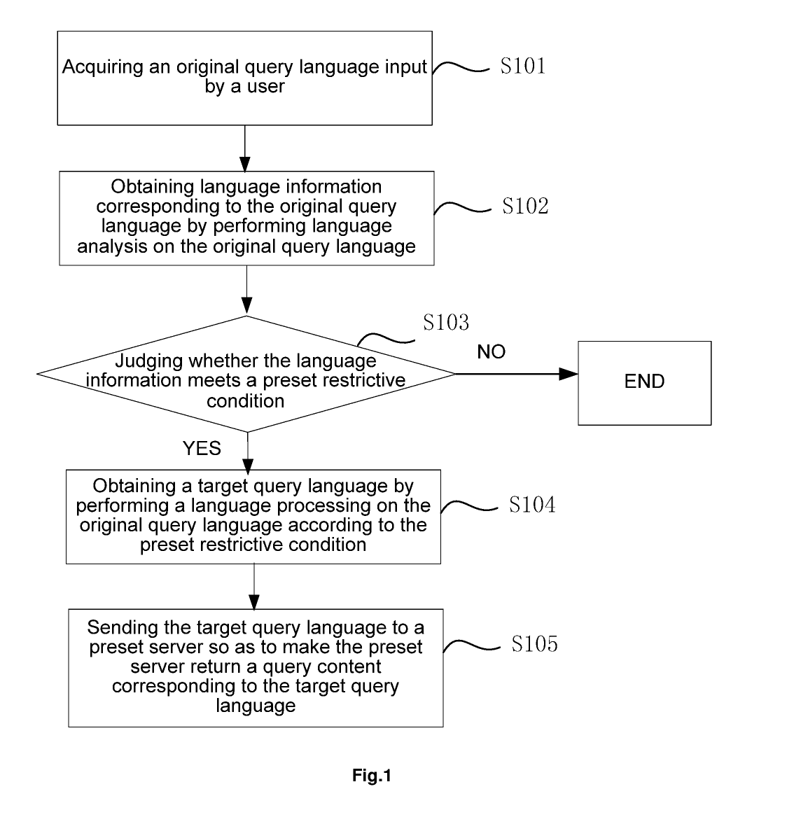

FIG. 1 is a flow chart of a method for controlling data query according to an exemplary embodiment. The method may be applied to a server, as shown in FIG. 1, and the method may include the following steps.

In Step S101: acquiring an original query language input by a user.

A client may be connected with a server via a network. A database may be set in the server, and a query program or a query window of the database may be run on the client. The user may input a language to be queried to the query program or query window, and the language input at this point is referred to as an original query language.

For databases of different structures in the server, when a user inputs a query language, the format of the original query language input should be consistent with the format of the database queried, thus it may be guaranteed that the original query language input can be recognized and the corresponding data can be looked up in the database.

In Step S102: obtaining language information corresponding to the original query language by performing language analysis on the original query language.

Referring to the above description related to Step S101, the format of the query language input should be the same as the format of the database queried, and in this step, the original query language may be analyzed according to the corresponding format. No matter what format the database has, the rule of the query language is specific, that is, the content contained in the query language is specific.

For example, the query language is: select deptNo, deptName, sales, score from dept.

Wherein, “select” is a query action, which refers to a selection action; the “deptNo, deptName, sales, score” that follows refers to the content to be queried; and “from dept” refers to the query location.

It may be seen that, by analyzing the query language, it may be known that the language information of the query language is to select parameters “deptNo, deptName, sales, score” from “dept”.

In Step S103: judging whether the language information meets a preset restrictive condition.

The preset restrictive conditions are some restrictions on the query of the current original query language. If no preset restrictive condition is set, it can be imagined that a user can search for any data in a database by inputting a query language arbitrarily.

In an embodiment of the present disclosure, the preset restrictive condition may include a combination of one or more of a query right, a restriction on the number of query results, a restriction on the number of words of a query result and a sensitive content in a fuzzy query result, wherein, the query right is directed to users, and the content that can be queried by each user is limited; restriction on the number of query results refers to that only a set number of results can be queried by a user during a query; restriction on the number of words of a query result refers to that, during each query, the number of words in the result obtained by a user in a query is limited; and sensitive content in a fuzzy query result refers to that some sensitive contents in the query result needs to be filtered off.

The above preset restrictive conditions on the query result are only illustrative, and in specific implementation, one skilled in the art may also set other restrictive conditions freely according to practical situations.

When the language information meets the preset restrictive condition, it turns to Step S104; otherwise, the process ends.

In Step S104: obtaining a target query language by performing a language processing on the original query language according to the preset restrictive condition.

If the language information meets the preset restrictive condition, it indicates that the current original query language needs to be restricted. In an embodiment of the present disclosure, the current query result is made to meet the restriction of the preset restrictive condition by processing the original language.

In an embodiment of the disclosure, the processing the original query language may refer to adding some language to or deleting some language from the original query language so as to attain the object of restricting the current query.

In Step S105: sending the target query language to a preset server so as to make the preset server return a query content corresponding to the target query language;

After the original query language is processed, the target query language obtained after the language processing may be directly sent to the server, so that it may query in the corresponding database in the server according to the target query language and send the query content obtained to the sending party of the target query language, for example, the above client.

In the method for controlling data query according to the embodiments of the present disclosure, first of all, language information that may characterize the meaning of the original query language is obtained by performing language analysis on the original query language, then it judges whether the language information meets a specific preset restrictive condition, once it meets the preset restrictive condition, the original query language will be processed according to a mode corresponding to the preset restrictive condition, thus a target query language processed is obtained, and finally the target query language is sent to the server for query.

Therefore, when the method is utilized for data query, if a user needs to query a database in the server, the database is not directly queried according to the original query language input by the user; instead, after the original query language is obtained, it will be processed and then used for query. As a result, the user cannot query any data in the database except for some specific data. Therefore, it may be avoided that the information, which does not belong to the user, is leaked out, and the security of data query may be improved.

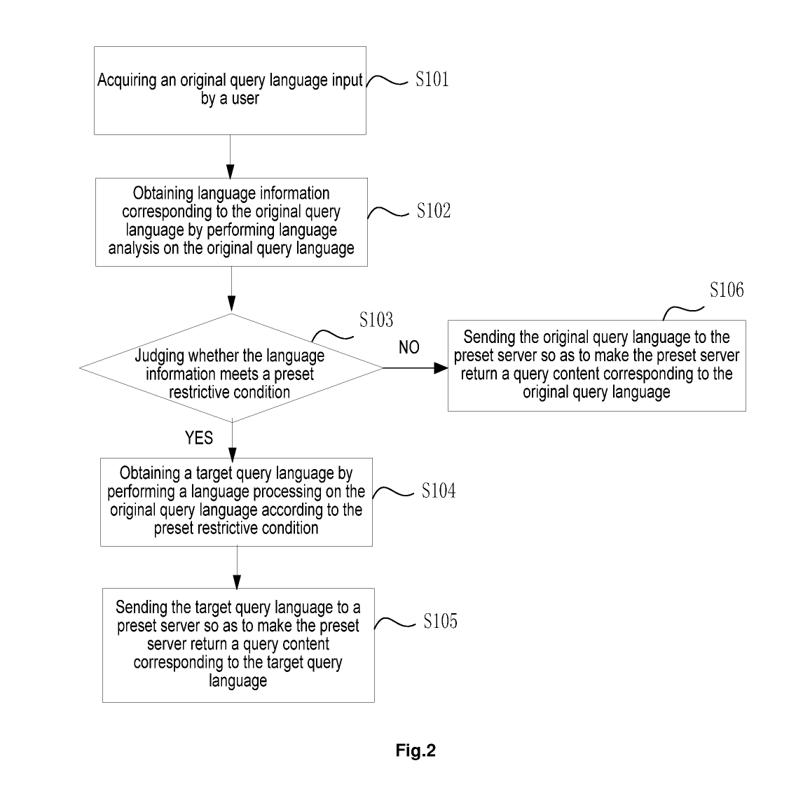

In an embodiment of the present disclosure, as shown in FIG. 2, when the language information does not meet the preset restrictive condition, the method according to the embodiment of the present disclosure may further include the following step.

In Step S106: sending the original query language to the preset server so as to make the preset server return a query content corresponding to the original query language.

Because the language information of the original query language does not meet the preset restrictive condition, during query, it may directly search for the data according to the original query language. Therefore, in this step, the original query language is directly sent to the preset server, so that the server searches for the data totally according to the original query language.

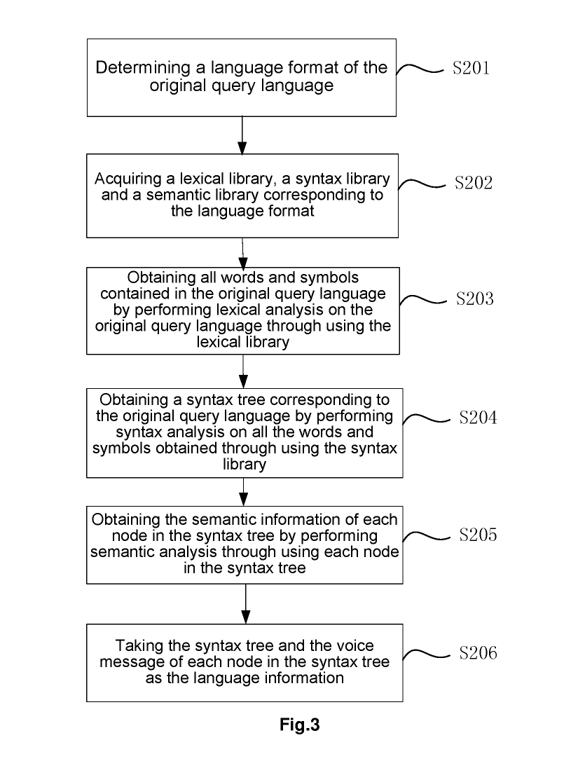

In another embodiment of the present disclosure, as shown in FIG. 3, the Step S102 in the embodiment shown in FIG. 1 may include the following steps.

In Step S201: determining a language format of the original query language.

For different databases, the language format of the query language will be different.

In Step S202: acquiring a lexical library, a syntax library and a semantic library corresponding to the language format;

For different databases, a lexical library, a syntax library and a semantic library corresponding to the language format may be preset, so that the query language may be analyzed after it is obtained.

In Step S203: obtaining all words and symbols contained in the original query language by performing lexical analysis on the original query language through using the lexical library.

In the embodiment of the present disclosure, a Structured Query Language (SQL) database is taken as an example, and illustration will be given below in conjunction with a specific case.

TABLE 1

| deptNo | deptName | sales | score |
|---|---|---|---|
| d001 | Sales Department | 10000 | 1.2 |
| d002 | Human Resource | 5000 | 0.9 |
| d003 | Purchase Department | 8000 | 1.1 |
| d004 | Information Department | 7000 | 1.0 |

The above table is a data table in the data, and the name of the table is “Dept”. The table contains the sales data and scores of different departments, wherein, deptNo, deptName, sales and score are different columns in the table respectively, and deptNo represents department number, deptName represents department name, sales represents sales volume, and score represents score.

The restrictive conditions below are set in the database, for example:

TABLE 2

| userID | resource | access |
|---|---|---|
| u01 | d001 | 1 |
| u01 | d002 | 1 |

Table 2 is a right table, wherein, userID refers to user ID, resource refers to department number in the table, and access refers to that it may be accessed.

It may be known from Table 2 that, user 01 has a right to access departments d001 and d002, but has no right to access other departments.

When the original query language input by user 01 is:

“select deptNo, deptName, sales, score from dept”,

It refers to that user 01 wants to query all department numbers, department names, sales volumes of different departments and scores of different departments, etc., from the table “dept”. However, referring to the above Table 2, user 01 only has the right to access d001 and d002.

Therefore, it can only be avoided that the data of the two departments d003 and d004 are leaked to user 01 by processing the above original query language.

In this step, by lexical analysis, i.e., by performing word partition on all the characters in the original query language, the phrases obtained finally includes: [select, deptNo, deptName, sales, score, from, dept], etc.

In Step S204: obtaining a syntax tree corresponding to the original query language by performing syntax analysis on all the words and symbols obtained through using the syntax library.

In the embodiment of the present disclosure, the syntax tree contains a plurality of nodes.

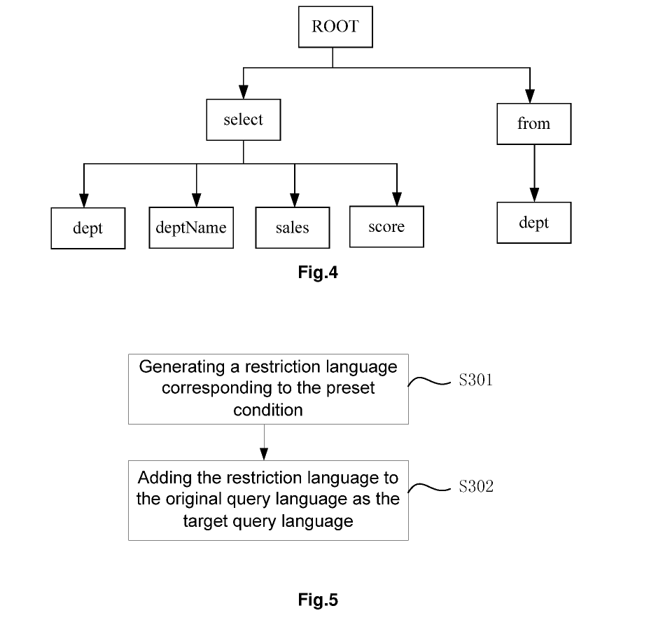

Referring to FIG. 4, it shows a structural representation of a syntax tree obtained by analyzing the above query language.

In Step S205: obtaining the semantic information of each node in the syntax tree by performing semantic analysis through using each node in the syntax tree.

It may be seen from FIG. 4 that, Root refers to a root node, and below the root node are respectively query instruction words which then point to objects. Via the semantic analysis on the syntax tree, the meaning expressed by the original query language, i.e., the language information may be obtained.

In Step S206: taking the syntax tree and the voice message of each node in the syntax tree as the language information.

In another embodiment of the present disclosure, as shown in FIG. 5, the above Step S104 may include the steps.

In Step S301: generating a restriction language corresponding to the preset condition.

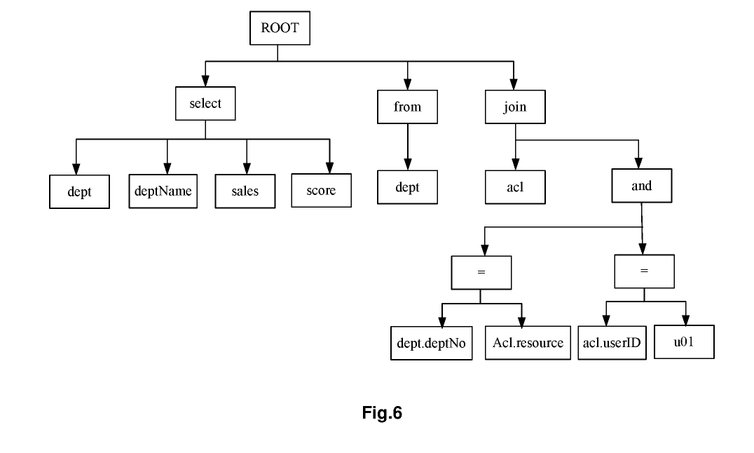

For the above case, because user 01 only has the right to access d001 and d002, it needs to prevent the user from accessing data of d003 and d004. Referring to FIG. 6, it shows a schematic diagram after improvements are made on the syntax tree. In FIG. 6, the English expressions are all abbreviations of program codes used by one skilled in the art, rather than being English words, and they will not be again introduced one by one here.

It may be seen from the syntax tree shown in FIG. 6 that, the syntax tree improved can make the user only able to access d001 and d002. According to the syntax tree shown in FIG. 6, the following restriction language may be generated:

join acl on dept.deptNo=acl.resource and acl.userID=‘u01’;

In Step S302: adding the restriction language to the original query language as the target query language.

After a restriction language is generated in Step S02, the restriction language is directly added to the original query language so that the target query language may be obtained, for example:

select deptNo, deptName, sales, score from dept

join acl on dept.deptNo=acl.resource and acl.userID=‘u01’

After the above process, the query result obtained finally by querying via the target query language is shown in the table below:

TABLE 3

| deptNo | deptName | sales | score |
|---|---|---|---|
| d001 | Sales Department | 10000 | 1.2 |
| d002 | Human Resource | 5000 | 0.9 |

It may be seen that, by the above adding a restriction language to the original query language, the query content obtained by the user 001 finally only contains the data of d001 and d002, without the data of d003 and d004.

Description will be given below in conjunction with another specific case. In this case, the preset restrictive condition is: a sensitive content in a fuzzy query result.

Similarly, by taking Table dept as an example, a data table provided by the background is as shown in Table 4:

TABLE 4

| deptNo | deptMD5No | deptName | sales | score |
|---|---|---|---|---|
| d001 | 00003210fds | Sales Department | 10000 | 1.2 |
| d002 | 00003210faw | Human Resource | 5000 | 0.9 |
| d003 | 00003210gfd | Purchase Department | 8000 | 1.1 |
| d004 | 00003210kgf | Information Department | 7000 | 1.0 |

In Table 4, the column deptNo is sensitive information. Therefore, during a query on Table dept, it needs that the content of column deptNo in the query result is deleted, thereby the sensitive information is removed.

For user 01, it is hypothesized that the original query language input is:

select deptNo, deptName, sales, score from dept;

After the original query language is received, it needs to be analyzed, and the phrases obtained after lexical analysis are as follows:

[select, deptNo, deptName, sales, score, from, dept]

Then, syntax analysis is performed on the above phrases, and a syntax tree as shown in FIG. 4 is obtained.

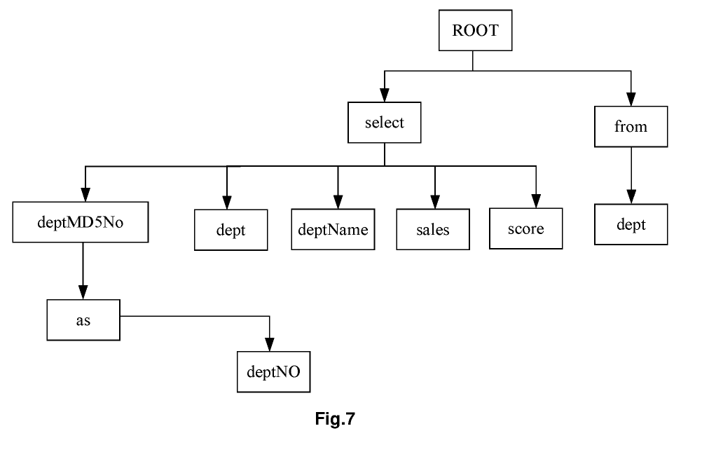

Because deptNo is sensitive information, it needs to be screened. During the screening, the following syntax tree may be obtained, as shown in FIG. 7.

It may be known according to the above FIG. 7 that, in this embodiment, the restriction language obtained finally may be:

deptMD5No as deptNo;

Therefore, the above restriction language is added to the historical query language, and the target query language finally obtained may be:

select deptMD5No as deptNo, deptName, sales, score from dept

For the query result finally obtained according to the above target query language, reference may be made to Table 5:

TABLE 5

| deptNo | deptName | sales | score |
|---|---|---|---|
| 00003210fds | Sales Department | 10000 | 1.2 |
| 00003210faw | Human Resource | 5000 | 0.9 |
| 00003210gfd | Purchase Department | 8000 | 1.1 |
| 00003210kgf | Information Department | 7000 | 1.0 |

It may be seen from Table 5 that, the data in the column deptNo have been screened off, and the column deptNo will not be displayed in the result acquired by the user, thereby it may be avoided that information is leaked out during query.

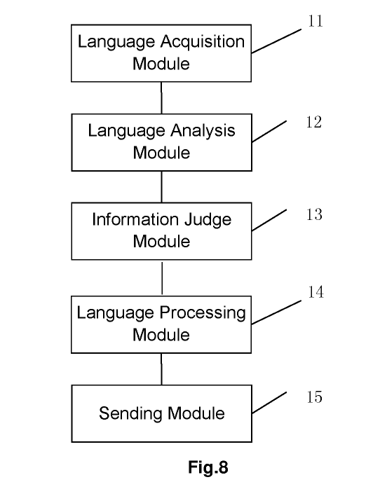

FIG. 8 is a structural representation of a device for controlling data query according to an embodiment of the present disclosure. As shown in FIG. 8, the device may include:

a language acquisition module 11, configured to acquire an original query language input by a user;

a language analysis module 12, configured to obtain language information corresponding to the original query language by performing language analysis on the original query language;

an information judge module 13, configured to judge whether the language information meets a preset restrictive condition;

a language processing module 14, configured to, when the language information meets the preset restrictive condition, obtain a target query language by performing a language processing on the original query language according to the preset restrictive condition; and

a sending module 15, configured to send the target query language to a preset server so as to make the preset server return a query content corresponding to the target query language.

In another embodiment of the present disclosure, the above language sending module 15 is further configured to, when the language information does not meet the preset restrictive condition, send the original query language to the preset server so as to make the preset server return a query content corresponding to the original query language.

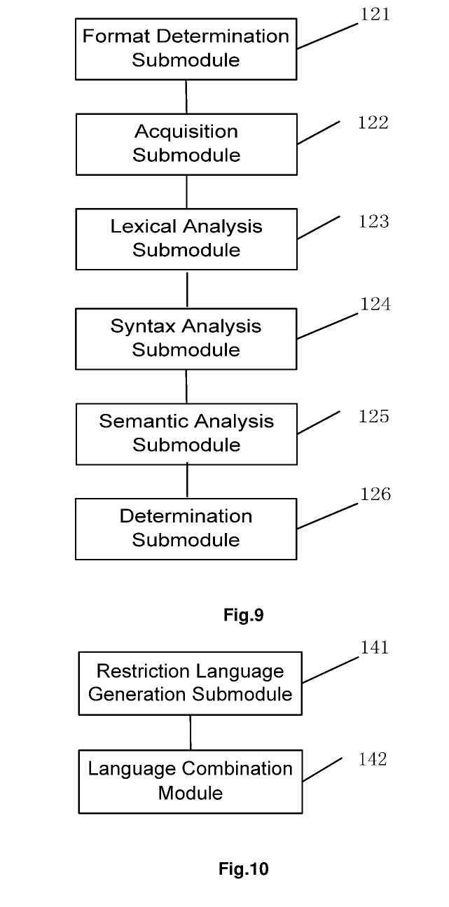

In an embodiment of the present disclosure, as shown in FIG. 9, the language analysis module 12 shown in FIG. 8 includes:

a format determination submodule 121, configured to determine a language format of the original query language;

an acquisition submodule 122, configured to acquire a lexical library, a syntax library and a semantic library corresponding to the language format;

a lexical analysis submodule 123, configured to obtain all words and symbols contained in the original query language by performing lexical analysis on the original query language through using the lexical library;

a syntax analysis submodule 124, configured to obtain a syntax tree corresponding to the original query language by performing syntax analysis on all the words and symbols obtained through using the syntax library, wherein the syntax tree contains a plurality of nodes;

a semantic analysis submodule 125, configured to obtain the semantic information of each node in the syntax tree by performing semantic analysis through using each node in the syntax tree; and

a determination submodule 126, configured to take the syntax tree and the voice message of each node in the syntax tree as the language information.

In an embodiment of the present disclosure, as shown in FIG. 10, the language processing module 14 shown in FIG. 8 includes:

a restriction language generation submodule 141, configured to generate a restriction language corresponding to the preset condition; and

a language combination module 142, configured to add the restriction language to the original query language as the target query language.

An embodiment of the present disclosure further provides a computer storage media, wherein, the computer storage medium may be stored with a program. The method for controlling data query provided in any one of the embodiments as shown in FIGS. 1 to 7 may be implemented when the program is executed.

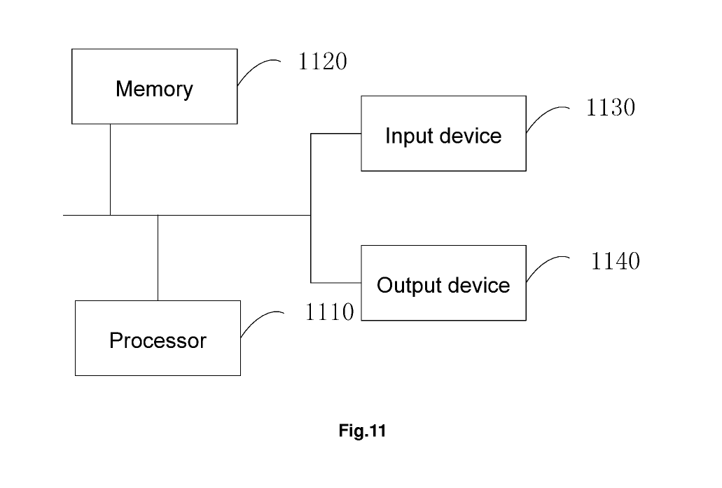

An embodiment of the present disclosure further provides an electronic device, as shown in FIG. 11, which includes:

one or more processors 1110 and a memory 1120. In FIG. 11, only one processor 1110 is shown as an example.

The device for executing the method for controlling data query may further include: an input device 1130 and an output device 1140.

The processor 1110, the memory 1120, the input device 1130 and the output device 1140 may be connected by bus or other means. FIG. 11 shows the devices are connected by bus as an example.

The memory 1120 is a nonvolatile computer-readable storage media, which may be used to store nonvolatile software program, nonvolatile computer-executable program and module, such as the program instruction/module (for example, the various modules shown in FIGS. 8 to 10, etc.) corresponding to the method for controlling data query of the embodiments of the present disclosure. The processor 1110 may perform various functions and applications of the server and process data by running the nonvolatile software program, instructions and modules stored in the memory 1120 so as to realize the method for controlling data query of the examples aforementioned.

The memory 1120 may include a program storage area and a data storage area, wherein the program storage area may store an operation system and an application program for achieving at least one function; the data storage area may store data established according to the use of the device for controlling data query and so on. In addition, the memory 1120 may include a high-speed random access memory, and may further include a non-volatile memory, such as at least one of magnetic disk memory, flash memory or other non-volatile solid state memory. In some examples, the memory 1120 may preferably include memories set remotely with respect to the processor 1110, wherein these remote memories may be connected to the device for controlling data query via the network. The examples of the network include but are not limited to internet, intranet, local area network (LAN), mobile communication network and their combinations.

The input device 1130 may receive the information of a number or a character as inputted, and generate key input signals relating to the user setting and function control of the device for controlling data query. The output device 1140 may include a display device such as a display screen.

The one or more modules are stored in the memory 1120. When the one or more modules are executed by one or more processors 1110, the method for controlling data query according to any of the above examples are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

The electronic device of the embodiments of the present disclosure may be embodied in various forms, which include but are not limited to the following device.

(1) Mobile communication device, which is characterized by the mobile communication function, and the main objective of which is to provide voice communication and data communication. This kind of terminal includes: smart phone (e.g. iPhone), multimedia phone, feature phone and low-level phone etc.

(2) Ultra mobile personal computer device, which belongs to the range of personal computer, has the function of computing and processing and generally can also be used in mobile internet. This kind of terminal includes: PDA, MID and UMPC device etc., such as iPad.

(3) Portable entertainment device, which may display and play multimedia contents. This kind of device includes: audio and/or video player (e.g. iPod), hand-held game machine, electronic book device, smart toy and portable vehicle navigation device.

(4) Server, which is a device that provides computing service. The configuration of the server includes processor, hard disk, memory and system bus etc. The architecture of a server is similar to that of a general computer. However, the sever has a higher demanding with respect to the processing ability, stability, reliability, safety, expansibility and manageability etc, because the server is required to provide more reliable service.

(5) Other electronic devices, which have the function of data interaction.

The examples of the device have been described above for illustrative purposes only, wherein the units described as separated members may or may not be separated physically. The members shown as units may or may not be physical unit, that is, they may be located at one place, or may be distributed to a number of units in a network. The objective of the examples of the present disclosure may be achieved by selecting a part or all of the modules according to actual demand.

From the description of the above examples, the person skilled in the art may understand clearly that respective examples may be implemented by software in combination with a hardware platform, or by hardware only. Based on this understanding, the nature or the part contributory to the prior art of the technical solution as described above may be embodied in the form a computer software product, which may be stored in a computer-readable storage media, such as ROM/RAM, magnetic disk, optical disk etc., and may include a number of instructions for making a computer device (which may be a personal computer, a server or a network device etc.) execute the method according to the respective examples or a part of an example.

Finally, it should be noted that the examples as described above are only for the purpose of illustrating the solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the present application as defined in the accompanying claims.

What is claimed is:

1. A method for controlling data query, comprising:
acquiring an original query language input by a user;
obtaining language information corresponding to the original query language by performing language analysis on the original query language;
judging whether the language information meets a preset restrictive condition;
obtaining a target query language by performing a language processing on the original query language according to the preset restrictive condition, when the language information meets the preset restrictive condition; and
sending the target query language to a preset server so as to make the preset server return a query content corresponding to the target query language.

2. The method according to claim 1, further comprising:
sending the original query language to the preset server so as to make the preset server return a query content corresponding to the original query language, when the language information does not meet the preset restrictive condition.

3. The method according to claim 1, wherein, the obtaining language information corresponding to the original query language by performing language analysis on the original query language comprises:
determining a language format of the original query language;
acquiring a lexical library, a syntax library and a semantic library corresponding to the language format;
obtaining all words and symbols contained in the original query language by performing lexical analysis on the original query language through using the lexical library;
obtaining a syntax tree corresponding to the original query language by performing syntax analysis on all the words and symbols obtained through using the syntax library, wherein the syntax tree contains a plurality of nodes;
obtaining the semantic information of each node in the syntax tree by performing semantic analysis through using each node in the syntax tree; and
taking the syntax tree and the voice message of each node in the syntax tree as the language information.

4. The method according to claim 1, wherein, the preset restrictive condition comprises: a query right, a restriction on the number of query results and/or a restriction on the number of words of a query result.

5. The method according to claim 4, wherein, the obtaining a target query language by performing a language processing on the original query language according to the preset restrictive condition comprises:
generating a restriction language corresponding to the preset condition; and
adding the restriction language to the original query language as the target query language.

6. A nonvolatile computer storage media, which stores computer-executable instructions, wherein the computer-executable instructions are configured to:
acquire an original query language input by a user;
obtain language information corresponding to the original query language by performing language analysis on the original query language;
judge whether the language information meets a preset restrictive condition;
obtain a target query language by performing a language processing on the original query language according to the preset restrictive condition, when the language information meets the preset restrictive condition; and
send the target query language to a preset server so as to make the preset server return a query content corresponding to the target query language.

7. The nonvolatile computer storage media according to claim 6, wherein, the electronic device is further caused to:
send the original query language to the preset server so as to make the preset server return a query content corresponding to the original query language, when the language information does not meet the preset restrictive condition.

8. The nonvolatile computer storage media according to claim 6, wherein, the step to obtain language information corresponding to the original query language by performing language analysis on the original query language comprises:
determining a language format of the original query language;
acquiring a lexical library, a syntax library and a semantic library corresponding to the language format;
obtaining all words and symbols contained in the original query language by performing lexical analysis on the original query language through using the lexical library;
obtaining a syntax tree corresponding to the original query language by performing syntax analysis on all the words and symbols obtained through using the syntax library, wherein the syntax tree contains a plurality of nodes;
obtaining the semantic information of each node in the syntax tree by performing semantic analysis through using each node in the syntax tree; and
taking the syntax tree and the voice message of each node in the syntax tree as the language information.

9. The nonvolatile computer storage media according to claim 6, wherein, the preset restrictive condition comprises: a query right, a restriction on the number of query results and/or a restriction on the number of words of a query result.

10. The nonvolatile computer storage media according to claim 9, wherein, the step to obtain a target query language by performing a language processing on the original query language according to the preset restrictive condition comprises:
generating a restriction language corresponding to the preset condition; and
adding the restriction language to the original query language as the target query language.

11. An electronic device, comprising:
at least one processor; and
a memory communicably connected with the at least one processor;
wherein the memory stores instructions executable by the at least one processor, and execution of the instructions by the at least one processor causes the at least one processor to:
acquire an original query language input by a user;
obtain language information corresponding to the original query language by performing language analysis on the original query language;
judge whether the language information meets a preset restrictive condition;
obtain a target query language by performing a language processing on the original query language according to the preset restrictive condition, when the language information meets the preset restrictive condition; and
send the target query language to a preset server so as to make the preset server return a query content corresponding to the target query language.

12. The electronic device according to claim 11, wherein, the processor is further used to execute:
send the original query language to the preset server so as to make the preset server return a query content corresponding to the original query language, when the language information does not meet the preset restrictive condition.

13. The electronic device according to claim 11, wherein, the step to obtain language information corresponding to the original query language by performing language analysis on the original query language comprises:
determining a language format of the original query language;
acquiring a lexical library, a syntax library and a semantic library corresponding to the language format;
obtaining all words and symbols contained in the original query language by performing lexical analysis on the original query language through using the lexical library;
obtaining a syntax tree corresponding to the original query language by performing syntax analysis on all the words and symbols obtained through using the syntax library, wherein the syntax tree contains a plurality of nodes;
obtaining the semantic information of each node in the syntax tree by performing semantic analysis through using each node in the syntax tree; and
taking the syntax tree and the voice message of each node in the syntax tree as the language information.

14. The electronic device according to claim 11, wherein, the preset restrictive condition comprises: a query right, a restriction on the number of query results and/or a restriction on the number of words of a query result.

15. The electronic device according to claim 14, wherein, the step to obtain a target query language by performing a language processing on the original query language according to the preset restrictive condition comprises:
generating a restriction language corresponding to the preset condition; and
adding the restriction language to the original query language as the target query language.
